(19) United States
(12) Patent Application Publication
(10) Pub. No.: US 2002/0164128 A1
(43) Pub. Date: Nov. 7, 2002

(54) Optical device

(75) Inventors: Yoshinobu Nekado, Tokyo (JP); Kazuhisa Kashihara, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 10/100,917

(22) Filed: Mar. 20, 2002

(30) Foreign Application Priority Data
Mar. 21, 2001 (JP) 2001-080951

(51) Int. Cl. G02B 6/26; G02B 6/12

(52) U.S. Cl. 385/50; 385/14

(57) ABSTRACT

While optical circuits of chips are optically connected to each other, an optical device capable of properly realizing such a setting function of a switching function is realized. Both a chip forming an optical waveguide and another chip forming another optical waveguide are arranged on substrates. A sandwiching member for sandwiching both upper surfaces and lower surfaces of these chips is provided in such a mode that this sandwiching member covers the optical connection regions of the optical waveguides. The sandwiching member is arranged by an elastic member provided in contact with the forming region of the chips, and also, a flat plate member provided in contact with a rear surface of the substrate. While stress is applied by a stress applying member, this sandwiching member sandwiches the upper surfaces and the lower surfaces of the chips.

### BACKGROUND OF THE INVENTION

Recently, in optical communications, as a method capable of rapidly increasing transmission capacities of these optical communications, many researches/developments of optical wavelength division multiplexing communications have been positively performed, and thus, the optical wavelength division multiplexing communications may be practically and gradually available. An optical wavelength division multiplexing communication corresponds to such an optical communication that, for instance, a plurality of lights having different wavelengths from each other are multiplexed with each other, and then, the multiplexed light is transferred. In such an optical wavelength division multiplexing communication system, various types of optical devices are required, for instance, an optical device having an optical demultiplexing function, an optical device having an optical multiplexing function, and an optical device having an optical switch function are required.

An optical device having an optical demultiplexing function corresponds to such an optical device which demultiplexes multiplexed light transmitted via a single transmission line every wavelength into a plurality of transmission lines or a plurality of optical lines. An optical device having an optical multiplexing function corresponds to such an optical device by which lights having different wavelengths from each other which are transmitted via a plurality of transmission lines are multiplexed to either a single transmission line or a plurality of transmission lines. An optical device having an optical switch function corresponds to an optical device having an optical transmission line switching function capable of switching transmission lines of light.

As the above-described optical devices, there are many optical devices that one, or more chips where optical circuits are formed are provided on a substrate. A chip for forming an optical device corresponds to, for example, a planar lightwave circuit (PLC), a composite type optical circuit, and the like.

A planar light wave circuit corresponds to such a circuit that an optical circuit of optical waveguides made of a silica-based material, a semiconductor-based material such as InP, and an organic material such as polyimide is formed on a substrate made of a semiconductor-based material such as silicon or silica-based material.

As one example of the above-explained composite type optical circuit, there is such an optical circuit manufactured by that a V-shaped, or a U-shaped grooves are formed in a substrate made of silica, or silicon, optical fibers are inserted into these grooves and are fixed in these grooves. As another example of the composite type optical circuit, an optical element connected to the above-described optical circuit is arranged on a substrate. The optical element to be connected to the optical circuit corresponds to light emitting/receiving elements such as a laser diode and a photodiode.

As a further example of the composite type optical circuit, instead of an optical circuit of optical fibers, while a planar lightwave circuit where an optical circuit of optical waveguide is formed is provided on a substrate, this planar lightwave circuit is optically connected to the above-described optical element arranged on the substrate.

An optical wavelength division multiplexing transmission is carried out by using a wavelength division transmission system. This wavelength division multiplexing transmission system has various connection modes, for instance, an optical connection between the above-described planar lightwave circuits, an optical connection between a planar lightwave circuit and optical fibers, an optical connection between optical fibers and a composite type optical circuit, and an optical connection between optical fibers and other optical fibers. There are many cases that when the above-described the optical fibers are connected to either the planar lightwave circuit or the composite type optical circuit, optical fibers are aligned on an optical fiber alignment tool to constitute an optical fiber block, and then, this optical fiber block is connected to a connection counter member.

On the other hand, in the case that optical circuits of chips which are formed by either the planar lightwave circuit (PLC) or the composite type optical circuit are connected to each other so as to form an optical device, normally, optical axes of these optical circuits are first of all aligned with each other by using either the active alignment or the passive alignment, which are well known in this optical field. Then, under this alignment condition, these chips are fixed to be held by using adhesive agent and the like in order that these chips are not positionally shifted, so that the resulting optical device is formed.

For instance, FIG. 8A and FIG. 8B schematically represent one example of the conventional optical device. In this optical device, an optical fiber 20 corresponding to an optical circuit of an optical fiber block 9a is optically connected to an optical waveguide (core) 21 corresponding to an optical circuit of a chip 9b. Also, this optical device is formed in such a manner that a plurality of optical waveguides 21 of the chip 9b are optically connected to a plurality of optical fibers 23 corresponding to an optical circuit of an optical fiber block 9c in correspondence with each other.

The optical fiber blocks 9a and 9c are formed in such a manner that the optical fibers 20 and 23 are aligned on optical fiber alignment tools 24 and 25, and the optical fibers 20 and 23 are depressed by upper plates 35 and 36, respectively. The chip 9b is formed in such a manner that a waveguide forming region 10 including the optical waveguide core 21 and a cladding 19 is formed on a substrate 1. An upper plate 33 and another upper plate 34 are provided on both end sides of this chip 9b.

While an edge surface of the optical fiber block 9a is fixed to one edge surface of the chip 9b by way of adhesive agent, the other edge surface of the chip 9b is fixed to one edge surface of the optical fiber block 9c.

### SUMMARY OF THE INVENTION

An optical device, according to an aspect of the present invention includes:

a plurality of chips in which optical circuit is formed on substrate each other; wherein:

the chips are arranged in such a manner that the optical circuit is optically connected to each other;

a sandwiching member for sandwiching both upper surfaces and lower surfaces of the chips is provided in such a manner that the sandwiching member covers both an optical connection region of the one sided of the optical circuit and an optical connection region of the corresponding side of the other optical circuit to be connected to each other; and

the sandwiching member contains both a flat plate member and an elastic member, while the flat plate member is provided in contact with any one of the upper surfaces and said lower surfaces of the chips, and the elastic member is provided in contact with the other side of the upper/lower surfaces.

### BRIEF DESCRIPTION OF THE DRAWINGS

Exemplary embodiments of the invention will now be described in connection with the accompanying drawings, wherein:

FIG. 1A is a structural diagram for indicating a major structure of an optical device of a first embodiment according to the present invention by way of a plan view;

FIG. 1B is an explanatory diagram for indicating the optical device according to the first embodiment by way of a sectional view in which the optical device is cut along a longitudinal direction of an optical fiber;

FIG. 1C is a sectional view of the optical device, taken along a line K-K′ of FIG. 1A;

FIG. 2A is an explanatory diagram for explaining a condition of a chip having a warp and a sandwiching member in the case that while an optical connection region of the chip having the warp is sandwiched by the sandwiching member applied to the first embodiment, application force “IN” is applied to the chip;

FIG. 2B is an explanatory diagram for explaining a condition of the chip having the warp and the sandwiching member in the case that while the optical connection region of the chip having the warp is sandwiched by the sandwiching member applied to the first embodiment, application force “2N” is applied to this chip;

FIG. 2C is an explanatory diagram for explaining a condition of the chip having the warp and the sandwiching member in the case that while the optical connection region of the chip having the warp is sandwiched by the sandwiching member applied to the first embodiment, application force “3N” is applied to this chip;

FIG. 2D is an explanatory diagram for explaining a condition of the chip having the warp and the sandwiching member in the case that while the optical connection region of the chip having the warp is sandwiched by the sandwiching member applied to the first embodiment, application force “4N” is applied to this chip;

FIG. 3A is a structural diagram for indicating a major structure of an optical device of a second embodiment according to the present invention by way of a plan view;

FIG. 3B is a sectional view for indicating the optical device, taken along a line L-L′ of FIG. 3A;

FIG. 4A is a graph for graphically showing light transmission wavelength characteristics of the optical device of the second embodiment according to the present invention and a comparison example thereof;

FIG. 4B is a graph for graphically indicating light transmission wavelength characteristics in the case that a region of a separated slab waveguide except for an effective light transmission region is depressed by either the sandwiching member applied to the second embodiment or a sandwiching member applied to the comparison example;

FIG. 5 is an explanatory diagram for showing a relationship between a light transmission center wavelength shift, and positions of an optical input waveguide and an optical output waveguide in an arranged waveguide type grating;

FIG. 6A is an explanatory diagram for representing an example of a stress applying member which is applied to an optical device of another embodiment according to the present invention;

FIG. 6B is an explanatory diagram for indicating an example of the stress applying member shown in FIG. 6A by way of a sectional view;

FIG. 7A is an explanatory diagram for explaining a condition of a chip having a warp and a sandwiching member in the case that while an optical connection region of the chip having the warp is sandwiched by the sandwiching member applied to further another embodiment, application force “N” is applied to the chip;

FIG. 7B is an explanatory diagram for explaining a condition of the chip having the warp and the sandwiching member in the case that while the optical connection region of the chip having the warp is sandwiched by the sandwiching member applied to further another embodiment, application force “2N” is applied to this chip;

FIG. 7C is an explanatory diagram for explaining a condition of the chip having the warp and the sandwiching member in the case that while the optical connection region of the chip having the warp is sandwiched by the sandwiching member applied to further another embodiment, application force “3N”is applied to this chip;

FIG. 7D is an explanatory diagram for explaining a condition of the chip having the warp and the sandwiching member in the case that while the optical connection region of the chip having the warp is sandwiched by the sandwiching member applied to further another embodiment, application force “4N” is applied to this chip;

FIG. 8A is an explanatory diagram for indicating the example of the conventional optical device;

FIG. 8B is an explanatory diagram for showing the example of the optical device indicating in FIG. 8A by way of a sectional view where the optical device is cut along the longitudinal direction of the optical fiber;

FIG. 9A is an explanatory diagram for explaining a condition of a chip having a warp and a sandwiching member in the case that while upper/lower optical connection regions of the chip having the warp are sandwiched by flat plate members, application force “N” is applied to the chip;

FIG. 9B is an explanatory diagram for explaining a condition of the chip having the warp and the sandwiching member in the case that while upper/lower optical connection regions of the chip having the warp are sandwiched by the flat plate members, application force “2N” is applied to this chip;

FIG. 9C is an explanatory diagram for explaining a condition of the chip having the warp and the sandwiching member in the case that while upper/lower optical connection regions of the chip having the warp are sandwiched by the flat plate members, application force “3N” is applied to this chip; and

FIG. 9D is an explanatory diagram for explaining a condition of the chip having the warp and the sandwiching member in the case that while upper/lower optical connection regions of the chip having the warp are sandwiched by the flat plate members, application force “4N” is applied to this chip.

### DETAILED DESCRIPTION

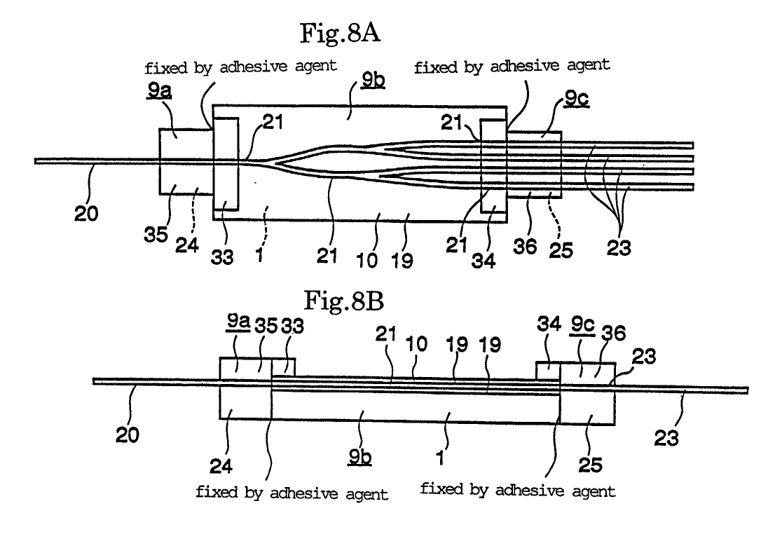

As previously described, an optical wavelength division multiplexing system requires an optical device having an optical switch function. In other words, the optical wavelength division multiplexing communication system requires such an optical device capable of switching an optical connection between an optical circuit of one chip and an optical circuit of the other chip to be connected to each other. Then, the following functions are strongly requested with respect to such an optical device having an optical switch function. That is, while this optical device optically connects both the optical circuits of the chips under better optical connection condition, setting functions (desirable functions) such as a switch function can be properly realized. However, as to the conventional optical device indicated in FIG. 8A and FIG. 8B, since both the chip 9b and the optical fiber blocks 9a, 9c are fixed/held with each other by using the adhesive agent, an optical switch function and the like cannot be given to the optical device.

In general, the chip 9b and the optical fiber blocks 9a, 9c for forming the above-described optical device have warps, which is caused by a difference between a substrate material and a material of a region for forming an optical circuit. Then, when the chip 9b and the optical fiber blocks 9a, 9c having the warps are optically connected to each other under direct conditions without fixing these chip 9b and the optical fiber blocks 9a, 9c having the warps, an optical axis shift may readily occur, so that connection losses would be increased. As a consequence, such an optical device capable of properly realizing the setting functions such as the above-explained optical switch function could not be so far realized, while the optical circuit of the chip and the optical fiber block are optically connected to each other under better optical connection condition.

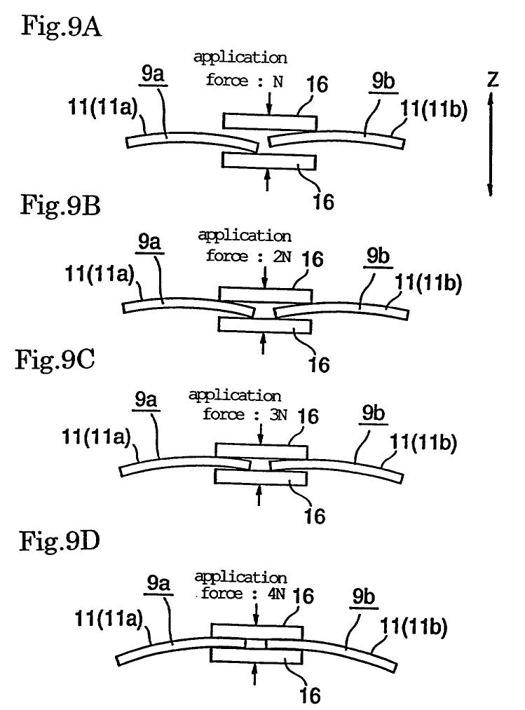

For example, as indicated in FIG. 9A and FIG. 9B, flat plate members 16 made of a silicon plate and the like are arranged on both lower surfaces and upper surfaces of the optical fiber block 9a and the chip 9b, both the upper and lower surfaces of the optical fiber block 9a and the chip 9b are sandwiched by the flat plate members 16, and then, either application force “N” or application force “2N” is applied to the optical fiber block 9a and the chip 9b. As a result, in response to stress applied to the optical fiber block 9a and the chip 9b, edge surfaces of the optical fiber block 9a and the chip 9b are moved along a height direction (namely, Z direction of FIG. 9A) of the optical fiber block 9a and the chip 9b, and are moved along such a direction that these edge surfaces of the optical fiber block 9a and the chip 9b are positionally aligned to each other.

However, as indicated in FIG. 9C and FIG. 9D, when the stress applied to the optical fiber block 9a and the chip 9b are increased to “3N” and “4N”, although the edge surface of the optical fiber block 9a is positionally aligned to the edge surface of the chip 9b, stress may be locally applied to a portion of an optical circuit forming region 11a of the optical fiber block 9a and a portion of an optical circuit forming region 11b of the chip 9b.

As a result, a large stress distribution may occur in the optical circuit forming regions 11a and 11b of the optical fiber block 9a and the chip 9b, so that refractive indexes are varied. Thus, wavelengths of light transmitted by the optical fiber block 9a and the chip 9b are changed, and also, transmission losses are changed and/or increased.

Under such a circumstance, as one example according to the present invention, such an optical device may be provided with employment of the following construction. That is, while both the upper and lower surfaces of the chips are sandwiched by a sandwiching member having a flat plate member and an elastic member, the above-described stress may be absorbed and dispersed by way of an elastic deformation of this elastic member. This construction of the optical device will be described more in detail with reference to the accompanying drawings based upon the below-mentioned embodiments.

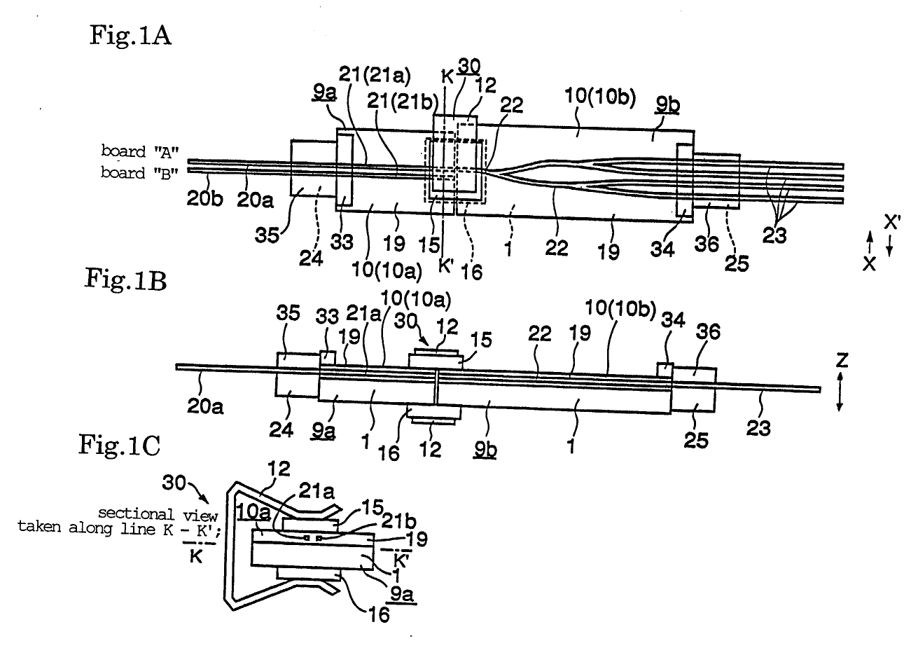

FIG. 1A and FIG. 1B illustratively indicate an optical device of a first embodiment according to the present invention. FIG. C is a sectional view of the optical device, taken along a line K-K′ of FIG. 1A. The optical device of this first embodiment is manufactured in such a manner that these structures shown in FIG. 1A to FIG. 1C are stored in package (not shown) filled with silicone oil.

The optical device of the first embodiment contains a plurality of chips 9a and 9b (in this embodiment, two chips). In the chip 9a, an optical waveguides 21 (namely, 21a and 21b) functioning as an optical circuit is formed on a substrate 1. In the chip 9b, an optical waveguides 22 functioning as an optical circuit is formed on the substrate 1. These chips 9a and 9b are arranged in such a mode that the optical waveguides 21 (21a and 21b) is optically connected to the optical waveguides 22.

Any of these optical waveguides 21 and 22 are embedded within a cladding 19. Each of waveguide forming regions 10 (namely, 10a and 10b) is formed by the optical waveguides 21, 22, and the cladding 19. An upper plate 33 is provided on an upper side of one edge side of the waveguide forming region 10a, and another upper plate 34 is provided on an upper side of one edge side of the waveguide forming region 10b.

In the first embodiment, a sandwiching member 30 which sandwiches the upper surfaces and the lower surfaces of the chips 9a and 9b is provided in such a mode that this sandwiching member 30 covers both an optical connection region of the optical waveguides 21 (21a and 21b) of the chip 9a and an optical connection region of the optical waveguides 22 of the chip 9b. In other words, the sandwiching member 30 is provided in such a manner that this sandwiching member 30 may cover both the optical connection region of the optical circuit provided on one side of the chip 9a, and the optical connection region of the optical circuit provided on the other side of the chip 9b which is connected to the chip 9a.

The sandwiching member 30 contains a flat plate member 16 and an elastic member 15, while the flat plate member 16 is provided in contact with the lower surfaces of the chips 9a and 9b, and also the elastic member 15 is provided in contact with the upper surfaces of the chips 9a and 9b. With employment of this structure, the flat plate member 16 is provided in contact with the substrate 1 whereas the elastic member 15 is provided in contact with the waveguide forming region 10.

As previously explained, in the optical device of the first embodiment, the sandwiching member 30 for sandwiching both the upper surfaces and the lower surfaces of both the chips 9a and 9b is provided in such a mode that this sandwiching member 30 covers both the optical connection regions of the optical circuit (namely, optical waveguides 21 of the chip 9a in this embodiment) provided on one side, and the optical circuit (namely, optical waveguides 22 of the chip 9b in this embodiment) provided on the other side, while the optical circuit of the chip 9a is connected to the optical circuit of the chip 9b. Also, in the first embodiment, the sandwiching member 30 has the flat plate member 16 provided in contact with any one side of the upper surfaces and the lower surfaces of the chips 9a and 9b, and also the elastic member 15 provided in contact with the other side thereof.

The sandwiching member 30 contains a stress applying member 12, while the stress applying member 12 applies stress to both the flat plate member 16 and the elastic member 15 along directions opposite to each other, so that this stress applying member 12 may apply the stress to the chips 9a and 9b to be connected to each other. As indicated in FIG. 1C, the stress applying member 12 is made of a copper-based spring member corresponding to a holding member which has an elastic characteristic, and has a “U like-shape” as viewed from a sectional view.

The stress applying member 12 is constructed in such a manner that stress may be applied along a direction perpendicular to a plane direction of the flat plate member 16. Even when the chips 9a and 9b has warps, this stress applying member 12 is arranged by that both the chips 9a and 9b may be sandwiched in a proper manner.

Furthermore, in accordance with the first embodiment, both a first contact position where the chip 9a is made in contact with the flat plate member 16, and also a second contact position where the chip 9b is made in contact with the flat plate member 16 are located from a boundary position between the chips 9a and 9b to be connected to each other by substantially equal distances. With employment of such a structure, in accordance with this first embodiment, the stress applied from the sandwiching member 30 to the chips 9a and 9b may be equally applied to the chips 9a and 9b.

In general, as previously explained, since the planar lightwave circuit has the warp, there are some cases that the chips 9a and 9b to be connected to each other have warps. In this case, these chips 9a and 9b are arranged in such a manner that the warp directions thereof are directed to the same directions.

There are many occurring factors as to wraps of the chips 9a and 9b. As one of these occurring factors, a difference between the material of the substrate 1 and the material of the waveguide forming region 10 is conceivable. Generally speaking, in such a planar lightwave circuit as the chips 9a and 9b applied in the first embodiment, if substrate having the same materials are employed, then warp directions thereof are directed to the same directions. This warp direction has a convex plane, as viewed in an upper direction, in such a case that a waveguide forming region made of a silica-based material is formed on a silicon substrate.

As a consequence, in this first embodiment, as previously described, since the flat plate member 16 is arranged on the lower surface sides (namely, on the side of substrate 1) of the chips 9a and 9b to be connected to each other, the flat plate member 16 is arranged on a concave plane side, and also the elastic member 15 is arranged on a convex plane side of the waveguide forming region 10.

The flat plate member 16 is formed by a silicon (Si) plate corresponding to a semiconductor material, whereas the elastic member 15 is formed by fluore-elastomer, for example, viton.

Normally, with respect to generally-used semiconductor materials such as Si, GaAs, and InP, these semiconductor materials are made sufficiently plane.

Such substrates made of these semiconductor materials may be readily available, the surface coarseness of which is small, the function force of which is small, and the flatness of which is high. Also, the substrates made of these semiconductor materials have such a merit that desirable sizes of the substrates can be manufactured by performing a simple processing method by way of cutting by a dicing saw, and the like, or a cleavage. Furthermore, the characteristics of the substrates made of these semiconductor materials can be hardly deteriorated which are caused by reactions with respect to silicone oil and the like.

Also, while “fluore-elastomer, for example, viton ” may be readily available, this rubber may be easily made with a desirable size. Further, since this “fluore-elastomer, for example, viton ” can have both the superior humidity resistant characteristic and the superior medicine resistant characteristic, the characteristics of this “fluore-elastomer, for example, viton ” with respect to reactions by silicone oil and the like can be hardly deteriorated.

The above-explained stress applying member 12 is manufactured as follows. That is, a plate of an elastic material is bent by employing, for example, a mold. This elastic material is employed as, for instance, a spring made of phosphor bronze, a spring made of beryllium copper, and so on. The stress applying member 12 may be easily formed in the above-explained manner.

The optical device of the first embodiment corresponds to such an optical device having an optical switch function. The optical device of the first embodiment has an optical switch driving unit (not shown). This optical switch driving unit switches optical connections of the optical circuits in such a manner that at least one chip (for example, chip 9a) of the chips 9a and 9b to be connected to each other is relatively moved with respect to the other chip (for example, chip 9b).

This optical switch driving unit is manufactured by employing, for instance, a gear and a stepper motor. The optical switch driving unit is so arranged that the chip 9a is moved with respect to the chip 9b along both an X direction and another X′ direction shown in FIG. 1A by an alignment pitch between the optical waveguide 21a of the chip 9a and the optical waveguide 21b of this chip 9a.

In the first embodiment, while an optical fiber alignment tool 24 is fixed on the chip 9a on the opposite side of the chip 9b, both an optical fiber 20a and another optical fiber 20b are aligned/fixed on this optical fiber alignment tool 24. An upper plate 35 is provided on the upper sides of the optical fibers 20a and 20b, so that an optical fiber block is formed.

Also, while another optical fiber alignment tool 25 is fixed on the chip 9b on the opposite side of the chip 9a, a plurality of optical fibers 23 are aligned/fixed on this optical fiber alignment tool 25. Another upper plate 36 is provided on the upper side of these optical fibers 23, so that another optical fiber block is formed.

While the optical device of this first embodiment is constructed in the above-described manner, for instance, under such a condition shown in FIG. 1A, the optical guidewave 21a of the chip 9a is optically connected to the end of one optical waveguide of the optical waveguides 22 of the chip 9b. Under this condition, when the chip 9a is relatively moved to the upper side with respect to the chip 9b by the above-described switch driving unit as represented by an arrow “X” of FIG. 1A, the optical waveguide 21b of the chip 9a may be optically connected to the end of one optical waveguide of the optical waveguides 22 of the chip 9b.

Thereafter, when the chip 9a is relatively moved along such a direction opposite to the above-explained direction, namely a direction indicated by an arrow X′ of FIG. 1A, by the optical switch driving unit, the optical waveguide 21a of the chip 9a is again and optically connected to the end of the one optical waveguide of the optical waveguides 22 of the chip 9b. As previously explained, the optical device of the first embodiment is featured by that the optical connection between the end of one optical waveguide of the optical waveguides 22 and the optical waveguides 21a/21b may be switched by moving the chip 9a along both the X direction and the X′ direction of FIG. 1A by using the optical switch driving unit.

Also, the optical device of the first embodiment is arranged by providing the sandwiching member 30 for sandwiching both the upper surfaces and the lower surfaces of the chips 9a and 9b in such a mode that this sandwiching member 30 may cover both the optical connection region of the optical waveguides 21 (21a and 21b) of the chip 9a and the optical connection region of the optical waveguides 22 of the chip 9b. As a consequence, in accordance with the optical device of this first embodiment, the edge surface of the chip 9a and the edge surface of the chip 9b can be aligned along the Z direction of FIG. 1B by applying the stress to the chips 9a and 9b.

Also, in the first embodiment, while the sandwiching member 30 has the flat plate member 16 arranged in contact with the substrate 1 and also the elastic member 15 arranged in contact with the waveguide forming region 10, this sandwiching member 30 sandwiches the chips 9a and 9b.

As a result, as indicated in the below-mentioned description, the stress which is applied from the stress applying member 12 to the chips 9a and 9b can be absorbed and dispersed by the elastic member 15. Then, the optical circuit of the chip 9a is optically connected to the optical circuit of chip 9b under such a condition that the optical connection regions are not positionally shifted along the height direction.

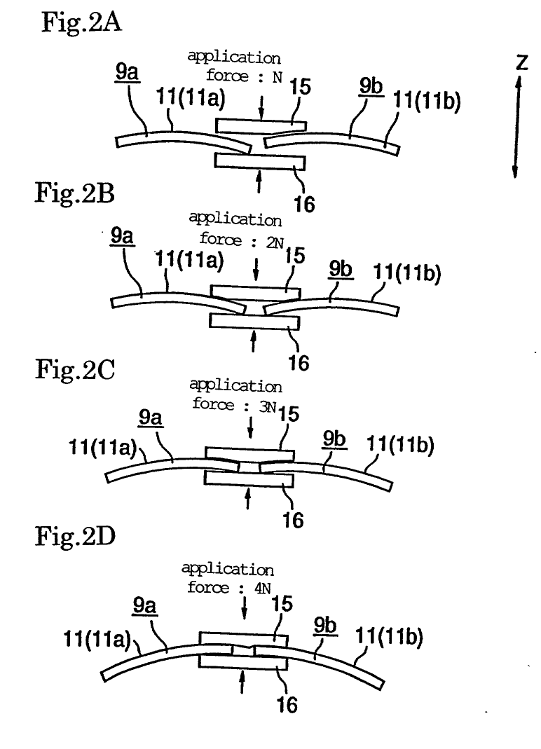

For instance, as shown in FIG. 2A and FIG. 2B, when application force “N” and “2N” are applied to the chips 9a and 9b, the edge surfaces of the chips 9a and 9b are moved along a height direction (namely, Z direction of FIG. 2A) in response to the applied stress. Then, as shown in FIG. 2C and FIG. 2D, when the application force is increased to “3N” and “4N”, the edge surface of the chip 9a is positionally aligned to the edge surface of the chip 9b along the height direction.

At this time, since the above-described stress is absorbed and dispersed by way of elastic deformation of the elastic member 15, the optical circuits of the chips 9a and 9b can suppress a change in wavelengths of light transmitted therethrough, a change in transmission losses, and an increase of transmission losses.

As a consequence, in accordance with the optical device of the first embodiment, since the chips can be optically connected to each other without deteriorating an integration characteristic of such a circuit in which the optical circuits are arranged in a higher integration manner, a total number of resulting chips which may be formed from a single wafer can be increased, and therefore, the optical device can be manufactured in low cost.

Also, in accordance with the first embodiment, since the elastic member 15 is deformed and the stress is dispersed, both the chips 9a and 9b to be connected to each other may be readily moved with respect to the direction located parallel to the surfaces of the chips 9a and 9b.

It should be understood that in response to the force applied to the chips 9a and 9b, the angles of the edge surfaces of both the chips 9a and 9b are slightly varied. However, the optical device of the first embodiment is arranged in such a manner that such properly-selected stress may be applied to these chips 9a and 9b in a stress application range where there is no problem in a transmission of light.

As a consequence, in accordance with the optical device of the first embodiment, while the optical connections between the optical waveguides 21a/21b of the chip 9a and the optical waveguides 22 of the chip 9b are maintained under better condition, the optical connection switching operation between the optical waveguides 21a/21b and the optical waveguides 22 can be carried out in the proper manner.

Also, in the optical device of the first embodiment, since the stress applying member 12 applies the stress to both the flat plate member 16 and the elastic member 15 along the directions opposite to each other, the stress is applied to both the chips 9a and 9b to be connected to each other. As a result, while the proper stress is applied to the chips by the stress applying member 12, these chips can be sandwiched.

Furthermore, in the optical device of the first embodiment, since the stress applying member 12 corresponds to such a holding member which has the elastic characteristic and has the “U like-shaped” sectional plane, the stress applying member capable of properly sandwiching the chips 9a and 9b can be easily formed.

Furthermore, in the first embodiment, since the stress applying member 12 is constituted by applying the stress along the direction perpendicular to the plane direction of the flat plate member 16, the chips 9a and 9b can be sandwiched by the sandwiching member 30 in the very proper manner. Also, since this structure of the optical device according to the first embodiment is employed, for example, when the chips 9a and 9b are moved along the direction of the substrate plane, the moving conditions of these chips 9a and 9b are not different from each other, depending upon the advance direction and the return direction, but also these moving operations of the chips 9a and 9b can be carried out in a correct manner.

Furthermore, in accordance with the optical device of the first embodiment, both the first contact position where the chip 9a is made in contact with the flat plate member 16, and the second contact position where the chip 9b is made in contact with the flat plate member 16 are set to be substantially equal distances from the boundary position between the chips 9a and 9b. As a consequence, in accordance with the optical device of the first embodiment, the stress applied from the sandwiching member 30 to the chips 9a and 9b can be equally applied to the chips 9a and 9b, these chips 9a and 9b can be sandwiched by the sandwiching member 30 in the very proper manner.

Furthermore, according to the optical device of the first embodiment, in the case that both the chips 9a and 9b to be connected to each other have the warps, since the chips 9a and 9b are arranged in such a manner that the warp directions thereof are mutually directed to the same directions, the sandwiching operation by the sandwiching member 30 can be readily carried out.

Furthermore, according to the optical device of the first embodiment, in the case that both the chips 9a and 9b to be connected to each other have the warps, the flat plate member 16 is provided on the concave plane side of the chips 9a/9b to be connected to each other, whereas the elastic member 15 is provided on the convex plane side thereof. As a consequence, in this first embodiment, since the flat plate member 16 made in contact with the concave plane side is depressed at multiple points by the sandwiching member 30, and thus, can be depressed under stable condition, the optical axis shift in the chips 9a and 9b can be more easily suppressed.

Furthermore, in accordance with the optical device of the first embodiment, since the flat plate member 16 is formed by the silicon plate, the flat plate member 16 having the desirable dimension can be readily manufactured, the plane precision of which is high, and also, the optical axes of the optical circuits formed on the chips 9a and 9b can be easily aligned. In addition, since the elastic member 15 is formed by employing the fluore-elastomer, for example, viton in accordance with the optical device of the first embodiment, the elastic member 15 can be readily formed.

As previously explained, since both the forming materials of the flat plate member 16 and the elastic member 15 are properly selected, the optical device of this first embodiment can maintain the above-explained effects for a long time duration, while the deterioration of the characteristic caused by the reaction with respect to the silicone oil can hardly occur.

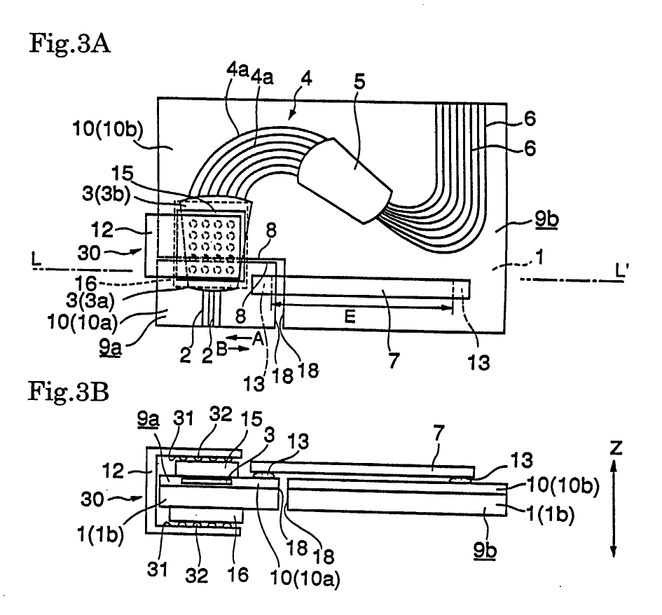

FIG. 3 schematically represents a major structural unit of an optical device of a second embodiment according to the present invention. It should also be noted the same explanations as those of the first embodiment are omitted in this second embodiment. Similar to the above-described first embodiment, the optical device of this second embodiment is manufactured in such a manner that these structures shown in FIG. 3A and FIG. 3B are stored in package (not shown), while this optical device has such package filled with silicone oil.

As represented in FIG. 3A and FIG. 3B, the optical device of the second embodiment contains a plurality of chips 9a and 9b (in this embodiment, two chips). In the chip 9a, a first waveguide forming region 10a is formed on a substrate 1a. In the chip 9b, a second waveguide forming region 10b is formed in another substrate 1b. These chips 9a and 9b are formed in such a manner that a planar lightwave circuit is separated by a cross separating plane cross 8 and non-cross separating plane 18, while this planar lightwave circuit is constituted by forming an optical circuit of an optical waveguides on the substrate 1.

It should be noted in this embodiment that the cross separating plane 8 is provided on a halfway of the waveguide forming region 10 from a left end side of FIG. 3A. A non-cross separating plane 18 is formed while being connected cross to this cross separating plane 8. Since the waveguide forming region 10 is separated from the cross 1 by these cross separating plane 8 and non-cross separating plane 18, the chips 9a and 9b are formed.

The optical circuit of the optical waveguides formed in the optical device of the second embodiment correspond to the below-mentioned optical circuit, and is embedded in the cladding 19. This optical circuit contains at least one of optical input waveguide 2, a first slab waveguide 3, an arrayed waveguide 4, a second slab waveguide 5, and a plurality of optical output waveguides 6. The first slab waveguide 3 is connected to an output side of the at least one of optical input waveguide 2. The arrayed waveguide 4 is connected to an output side of the first slab waveguide 3. The second slab waveguide 5 is connected to an output side of the arrayed waveguide 4. The plurality of optical output waveguides 6 are arranged side by side, and are connected to an output side of the second slab waveguide 5. This arrayed waveguide 4 is formed in such a manner that a plurality of channel waveguides 4a are arranged side by side. The lengths of a plurality of channel waveguides 4a are set by different setting amount from each other, while these channel waveguides 4a may transmit the light derived from the first slab waveguide 3.

The above-described cross separating plane 8 corresponds to such a plane used to separate the first slab waveguide 3 on a plane which is intersected with a path of light passing through the first slab waveguide 3. The first slab waveguide 3 is separated by the cross separating plane 8 into both separated slab waveguides 3a and 3b. The non-cross separating plane 18 is provided in such a mode that this non-cross separating plane 18 is not intersected with the optical circuit, while both the non-cross separating plane 18 and the cross separating plane 8 are provided perpendicular to each other. It should be noted that the non-cross separating plane 18 need not be intersected perpendicular to the cross separating plane 8, but FIG. 3A represents such a mode that this non-cross separating plane 18 is intersected perpendicular to the cross separating plane 8.

A slide moving member 7 is provided in such a mode that this slide moving member 7 bridges both the first optical waveguide forming region 10a and the second optical waveguide forming region 10b. The respective edge sides of the slide moving member 7 are fixed to the first optical waveguide forming region 10a and the second optical waveguide forming region 10b by way of a fixing unit 13. A thermal expansion coefficient of this slide moving member 7 is larger than that of the optical waveguide forming region 10 and the substrate 1.

This slide moving member 7 is constructed in such a manner that this slide moving member 7 may move at least one of the separated slab waveguides 3a and 3b along the cross separating plane 8 depending upon a temperature of an arrayed waveguide grating. In this case, the slide moving member 7 may move the separated slab waveguide 3a along the cross separating plane 8, depending on the temperature, and also, the slide moving member 7 may move the first optical waveguide forming region 10a along the cross separating plane 8 with respect to the second optical waveguide forming region 10b. When the temperature of the optical device is increased, the slide moving member 7 moves the first optical waveguide forming region 10a along a direction “A” of FIG. 3A, whereas when the temperature of the optical device is decreased, the slide moving member 7 moves the first optical waveguide forming region 10a along another direction “B” of FIG. 3A.

Also, in the second embodiment, since the slide moving member 7 is provided on the surfaces of the waveguide forming regions 10a and 10b in such a mode that this slide moving member 7 bridges both the waveguide forming region 10a and the waveguide forming region 10b, the below-mentioned effect can be achieved. That is, when the slide moving member 7 moves the waveguide forming region 10a, such a suppression effect may be achieved. This slide moving member 7 can suppress as much as possible such a fact that the waveguide forming region 10a is shifted along the Z direction perpendicular to the plane of the substrate.

Furthermore, in the second embodiment, such a sandwiching member 30 for sandwiching both the upper surfaces and the lower surfaces of the chips 9a and 9b are provided in such a mode that this sandwiching member 30 covers the separated region between the separated slab waveguides 3a and 3b corresponding to the optical connection regions of the optical circuits of the chips 9a and 9b to be connected to each other.

The construction of this sandwiching member 30 is substantially same as that of the sandwiching member 30 provided in the first embodiment. That is, an elastic member 15 is provided on the upper sides of the chips 9a and 9b (on the side of waveguide forming region 10), and a flat plate member 16 is provided on the lower side thereof (on the side of substrate 1). The flat plate member 16 for constituting the sandwiching member 30 is such a silicon substrate having a size of 8 mm×15 mm, and a thickness of 1 mm. Also, the elastic member 15 is formed by fluore-elastomer, for example, viton having a size of 6 mm'15 mm and a thickness of 1 mm.

In this second embodiment, as represented in FIG. 3B, the stress applying member 12 of the sandwiching member 30 is formed in such a manner that the plate material made of copper, or the like is bent at a right angle. This stress applying member 12 is made smaller than the above-described stress applying member 12 of the first embodiment.

Also, a plurality of projection portions 32 are formed in an integral manner on a sandwiching plane 31 of the stress applying member 12 employed in the optical device of the second embodiment. Thus, the stress applied from the stress applying member 12 may be equally applied to the chips 9a and 9b via the plurality of projection portions 32. The applied stress (clipping force) by the stress applying member 12 may be set to 3 Kgf.

The above-described slide moving member 7 is manufactured by, for example, a copper plate whose thermal expression coefficient is equal to 1.65×10⁻⁵ (1/K). The length of this slide moving member 7 is formed by which the temperature depending characteristic of the light transmission center wavelength of the arrayed waveguide type grating can be compensated.

It should also be understood that the Inventors of the present invention have investigated various aspects, while paying the specific attention to a linear dispersion characteristic of the arrayed waveguide type grating. Then, the Inventors could consider that the light transmission center wavelength of the arrayed waveguide type grating is compensated in such a way that the separated slab waveguide 3a is moved by the slide moving member 7 depending upon the temperature.

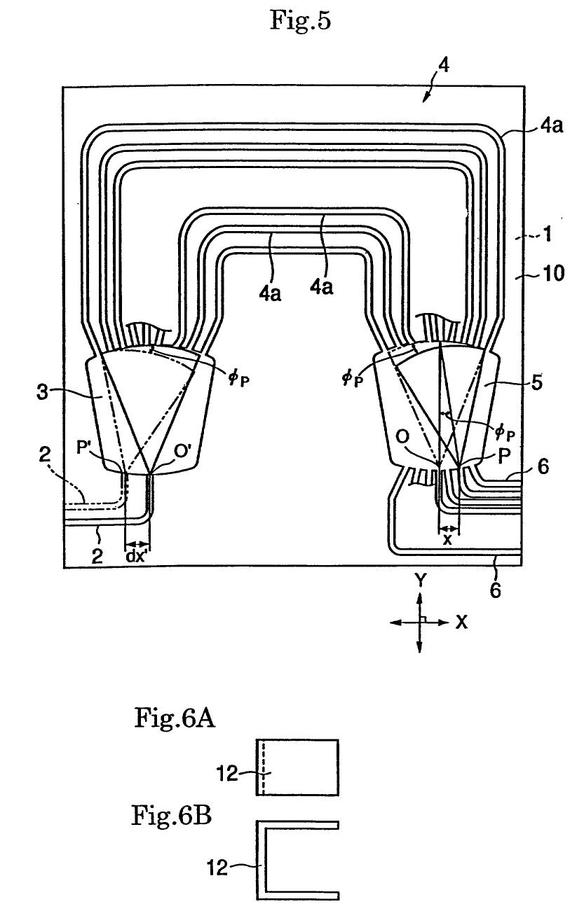

In other words, as represented in FIG. 5, assuming now that a focal center of the first slab waveguide 3 is set to a point “O′”, and also, such a point is set to another point “P′” whose location is shifted by a distance “dx′” from this point “O′” along the X direction. As a result, when light is entered into this point “P′”, a wavelength of an output of the optical output waveguide 6 may be shifted by “dλ′” as compared with the case of entering the light from the point “O′.” As a consequence, since the output end position of the optical input waveguide 2 is shifted, the output wavelength from the optical output waveguide 6 can be shifted.

Now, when a relationship between the above-described wavelength shift amount “dλ” and the X-direction move amount “dx′” of the output end position of the optical input waveguide 2 is expressed by a following formula, (1) may be obtained:

$$\frac{ⅆ {χ}^{′}}{ⅆ {λ}^{′}} = \frac{{L}_{f}^{′} \cdot Δ L}{{n}_{s} \cdot d \cdot {λ}_{0}} {n}_{g} \qquad formula ( 1 )$$

where, symbol “L_{f},” shows a focal distance of the first slab waveguide 3, symbol “ΔL” denotes a difference between lengths of adjacent channel waveguides, and symbol “nₛ” shows an equivalent refractive indexes of the first slab waveguide 3 and the second slab waveguide 5. Also, symbol “d” indicates an interval between the adjacent channel waveguides 4a, symbol “λ” indicates a light transmission center wavelength obtained where the diffraction angle φ=0 and also, symbol “n_{g}” indicates a group refractive index of the arrayed waveguide 4. Furthermore, the group refractive index “n_{g}” may be given by the following formula (2), while the equivalent refractive index “n_{c}” of the arrayed waveguide 4, and also, the transmission center wavelength “λ” of the light outputted from the optical output waveguide 6 are employed:

$${n}_{g} = {n}_{c} - {λ}_{0} \frac{ⅆ {n}_{c}}{ⅆ λ} . \qquad formula ( 2 )$$

As a consequence, in such a case that the transmission center wavelength of the light outputted from the optical output waveguide 6 of the arrayed waveguide type grating is shifted by “Δλ” depending upon the temperature, if the output end position of the optical input waveguide 2 is shifted by the distance “dx′” along the above-described X direction in such a manner that dλ′=Δλ, then such light having no wavelength shift can be derived from the optical output waveguide 6 which is formed at, for example, the focal point “O.”

Also, since the same operations may be carried out also as to another optical output waveguide 6, the transmission center wavelength shift “Δλ” of the light outputted from each of the optical output waveguides 6 can be corrected (canceled).

In accordance with the optical device of the second embodiment, while both the thermal expansion coefficient of the slide moving member 7 and the fixing position interval (namely, symbol “E” of FIG. 3A) are set by the proper manner, the light transmission center wavelength of the arrayed waveguide type grating may be compensated by expanding/compressing the slide moving member 7, depending upon the temperature.

In other words, the slide moving member 7 is expanded and/or compressed in accordance with the thermal expansion coefficient by such a length corresponding to the move amount of the separated slab waveguide 3a in response to the temperature-depending shift amount of the light transmission center wavelength of the arrayed wavelength type grating. The optical device of this second embodiment is arrayed in such a manner that both the separated slab waveguide 3a and the output end of the optical input waveguide 2 are moved along the X direction by this expansion/compression of the slide moving member 7 so as to compensate for the temperature depending characteristic of the light transmission center wavelength of the arrayed wavelength type grating.

The optical device of the second embodiment is arranged in accordance with the above-described construction. Similar to the above-described first embodiment, in accordance with the optical device of the second embodiment, since the chips 9a and 9b are sandwiched by the sandwiching member 30 having the flat plate member 16 and the elastic member 15, the optical axis of the separated slab waveguides 3a and 3b can be aligned along the Z direction. As a consequence, in the optical device of the second embodiment, while the insertion loss of the arrayed waveguide type grating can be reduced, it is possible to suppress the change in the transmission wavelengths, and the change/increase of the transmission losses in the arrayed waveguide type grating.

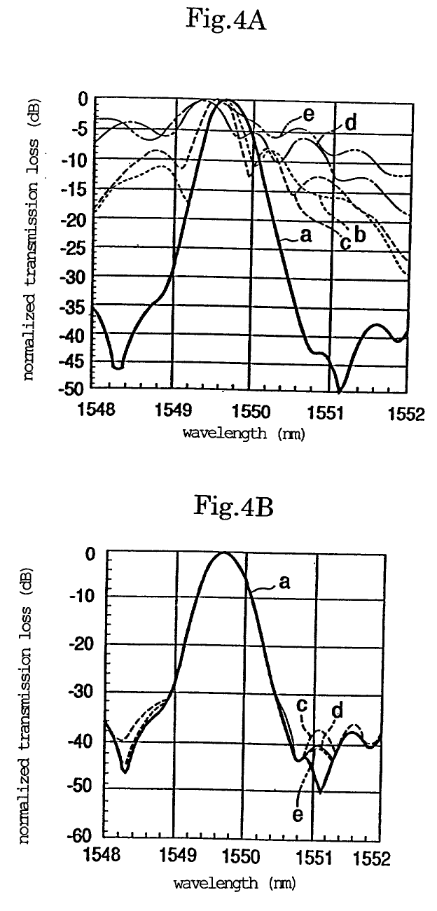

For instance, a characteristic line “a” of FIG. 4A indicates an example of a light transmission wavelength characteristic (transmission loss wavelength characteristic) of the second embodiment. As indicated in this characteristic line “a”, each of the light transmission center wavelengths in the second embodiment is substantially equal to the set wavelength, and the low crosstalk may be realized.

Also, characteristic lines “b” to “e” of FIG. 4A show light transmission wavelength characteristics of comparison examples of the second embodiment. The comparison examples having the characteristics of these characteristic lines “b” to “e” may be realized by that a region located near the center axis of the effective light transmission regions of the separated slab waveguides 3a and 3b is depressed by a clip, while these separated slab waveguides 3a and 3b are formed by separating the first slab waveguide 3 of the arrayed waveguide type grating.

While these comparison examples were formed, the Inventors of the present invention firstly separated the first slab waveguide 3 of the arrayed waveguide type grating so as to form both the two separated slab waveguides 3a and 3b. While the waveguide forming region 10 was used as the first and second waveguide forming regions 10a and 10b, both the chips 9a and 9b were formed. Then, the region located near the center axis of the effective light transmission regions of the separated slab waveguides 3a and 3b was depressed by employing the clip capable of suppressing the optical axis shift between the separated slab waveguides 3a and 3b along the Z direction perpendicular to the substrate plane. Also, while depression force of the clip was changed in the below-mentioned manner, examples of light transmission wavelength characteristics were acquired.

That is to say, in FIG. 4A, the characteristic line “b” indicates such a characteristic obtained when the depression force is selected to be 0.5 Kgf; the characteristic line “c” shows such a characteristic obtained when the depression force is selected to be 1.0 Kgf; the characteristic line “d” indicates such a characteristic obtained when the depression force is selected to be 3.0 Kgf; and the characteristic line “e” shows such a characteristic obtained when the depression force is selected to be 5.0 Kgf. As apparent from these characteristic lines “b” to “e”, in such a case that the region located near the center axis of the effective light transmission regions of the separated slab waveguides 3a and 3b is depressed by the clip, or the like, large crosstalk will occur and also wavelength shifts will occur in response to the magnitude of the depression force by the clip, or the like.

To the contrary, in the optical device of this second embodiment, as previously explained, even when the region located near the center axis of the effective light transmission regions of both the separated slab waveguides 3a and 3b is depressed by the sandwiching member 30, this optical device can avoid the large deterioration by the crosstalk and the occurrence of the wavelength shift.

In other words, in the optical device of the second embodiment, while the sandwiching member 30 has both the flat plate member 16 and the elastic member 15, this structure can suppress that the excessively local stress is applied to the waveguide forming region 10. As a consequence, in accordance with the second embodiment, as shown in the characteristic line “a” of FIG. 4A, even when the region located in the vicinity of the center axis of the effective light transmission regions of the separated slab waveguides 3a and 3b is depressed by the depression force (clipping force) of 3.0 Kgf, such an optical device capable of suppressing the change of the transmission wavelengths and also the deterioration by the crosstalk can be realized.

It should also be noted that the characteristic “a” of FIG. 4B shows such a light transmission wavelength characteristic obtained in the case that a region except for the effective light transmission regions of the separated slab waveguides 3a and 3b is depressed by using the sandwiching member applied to the second embodiment. Also, the characteristic lines “c” to “e” of FIG. 4B represent such light transmission wavelength characteristics in such a case that regions except for the effective light transmission regions of the separated slab waveguides 3a and 3b are depressed by the clip, or the like which are provided so as to suppress the optical axis shifts along the Z direction in the above-described comparison examples.

Also in FIG. 4B, the characteristic lines “c” to “e” show such characteristics obtained in the case that the depressing portion force by the clip is set to different values from each other. That is, the characteristic line “c” indicates such a characteristic obtained in the case that the depression force is selected to be 1.0 Kgf; the characteristic line “d” shows such a characteristic obtained in the case that the depression force is selected to be 3.0 Kgf; and the characteristic “e” represents a characteristic obtained in the case that the depression force is selected to be 5.0 Kgf.

It should be understood that the characteristic lines “c” to “e” of FIG. 4B are substantially same as the characteristics of the second embodiment indicated in the characteristic line “a” of FIG. 4B. As previously explained, in the case that the arranging position of the clip is set to the region other than the effective light transmission regions of the separated slab waveguides 3a and 3b, no large influence is given to the transmission loss wavelength characteristic of the arrayed waveguide type grating. However, since the optical device of the second embodiment can suppress the change in the transmission wavelengths and the deterioration by the crosstalk irrespective of the depression position, the integration characteristic of the optical waveguide circuits can be made better.

Also, in accordance with the optical device of the second embodiment, the sandwiching operation by the sandwiching member 30 may easily move the chips 9a and 9b along the cross separating plane 8. As a consequence, the slide moving member 7 can smoothly move the separated slab waveguide 3a along this cross separating plane 8 by a desirable distance.

Then, in accordance with the optical device of the second embodiment, since the separated slab waveguide 3a is moved along the cross separating plane 8 by this slide moving member 7, the temperature depending characteristic of the light transmission center wavelength of the arrayed waveguide type grating can be reduced. As a consequence, the second embodiment can realize such an optical device by which the light of the set wavelengths can be multiplexed and/or demultiplexed under stable condition irrespective of the temperature when this optical device is applied to the optical wavelength division multiplexing communication. As a consequence, the optical wavelength division multiplexing communication can be practically realized.

It should be understood that the present invention is not limited to the above-explained various embodiments, but may be modified, changed, or substituted without departing from the technical spirit and scope of the invention. For example, in each of the above-described embodiments, the silicon plate is applied as the flat plate member 16. Alternatively, this flat plate member 16 may be formed as such a plate manufactured by other semiconductor materials such as InP.

Also, in the respective embodiments, the elastic member 15 is formed by employing the fluore-elastomer, for example, viton. Alternatively, this elastic member 15 may be formed by employing an elastic member made of rubbers other than this fluore-elastomer, for example, viton.

Furthermore, in the second embodiment, the chips 9a and 9b are formed by separating the first slab waveguide 3 of the arrayed waveguide type grating by the cross separating plane 8. Alternatively, these chips may be formed by separating the second slab waveguide 5 by the separating plane. Also, both the first and second slab waveguides 3 and 5 may be separated by the separating plane to form these chips.

Furthermore, such a separating plane used to form the chips 9a and 9b by separating the arrayed waveguide type grating maybe formed as follows. In other words, this separating plane may be formed as at least one plane selected from a plane for separating connection portions between the optical input waveguides 2 and the first slab waveguide 3, another plane for separating at least a portion of the arrayed waveguide 4 along the longitudinal direction thereof, and another plane for separating connection portions between the second slab waveguide 5 and the optical output waveguides 6.

It should be noted that also in this case, since the slide moving member for moving at least one of the plural chips along the separating plane depending upon the temperature is employed, the effect capable of reducing the temperature depending characteristics of the light transmission center wavelength of the arrayed waveguide type grating can be achieved similar to, for example, that of the second embodiment.

Furthermore, the temperature-depending shift amount of the light transmission center wavelength of the arrayed waveguide type grating may be increased based upon the structure of the slide moving member. In this case, for instance, the slide moving member 7 is not provided under such a mode that this slide moving member 7 bridges both the first and second waveguide forming regions 10a and 10b. Instead, this slide moving member 7 may be arranged in such a manner that this slide moving member 7 bridges both the first waveguide forming region 10a and a base (not shown) which mounts the chips 9a and 9b. Then, when the temperature is increased, the first waveguide forming region 10a may be moved along the arrow-B direction of FIG. 3A. When the temperature is decreased, the first waveguides forming region 10a may be moved along the arrow-A direction of FIG. 3A.

Furthermore, the stress applying member 12 for constructing the sandwiching member 30 is constituted as indicated in FIG. 1C in the first embodiment, and is arranged as shown in FIG. 3B in the second embodiment. However, the structure of the stress applying member 12 is not specifically limited only to these structures. For example, this stress applying member 12 may be formed by having the structure (plan view) shown in FIG. 6A and the structure (sectional view) shown in FIG. 6B. Also, the material used to form the stress applying member 12 is not specifically limited, but may be properly selected.

Moreover, in the respective embodiments, the sandwiching member 30 is constituted by that the elastic member 15 is arranged on the side of the optical waveguide circuit forming regions 10 of the chips 9a and 9b, and also the flat plate member 16 is arranged on the side of the substrate 1. However, this sandwiching member 30 may be arranged as follows. That is, while this sandwiching member 30 sandwiches both the upper surfaces and the lower surfaces of the chips in such a mode that the sandwiching member 30 covers both the optical connection region of one optical circuit and the optical connection region of another optical circuit to be connected to each other, this sandwiching member 30 may have both the flat plate member 16 provided in contact with any one of the chips 9a/9b and the lower surfaces thereof, and also the elastic member 15 provided in contact with the other member.

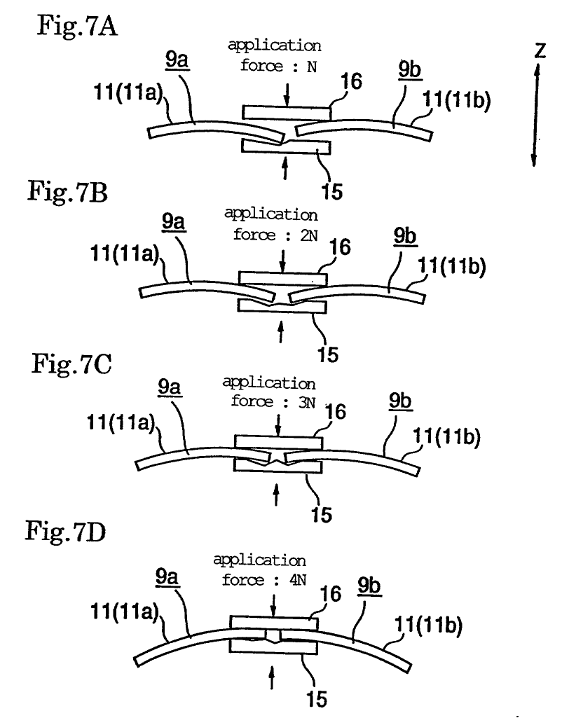

As previously explained, generally speaking, in the planar lightwave circuit, the convex-shaped warp is formed on the side of the waveguide forming region 10 as the optical circuit forming region 11. As a result, as indicated from FIG. 7A to FIG. 7D, when the flat plate member 16 is arranged on the side of the optical circuit forming regions 11a and 11b (namely, upper plane side of this drawing), the following conditions may be obtained.

In other words, even in the case that this structure is applied, the stress applied from the sandwiching member 30 to the chips 9a/9b is absorbed by the elastic member 15, the stress maybe locally and easily applied to the optical circuit forming regions 11a and 11b corresponding to the arranging side of the flat plate member 16. As a result, as explained in the respective embodiments, since the elastic member 15 is arranged on the side of the optical waveguide circuit forming regions 10 of the chips 9a/9b, and also the flat plate member 16 is arranged on the side of the substrate 1, the effect capable of suppressing the deterioration in the transmission wavelength characteristic can be properly achieved.

Moreover, the optical circuit arrangement of the chips which constitute the optical device according to the present invention is not specifically limited, but may be properly modified. For example, this optical circuit arrangement may be freely applied to various circuit arrangements, for instance, a splitter and a wavelength coupler. Also, the optical circuit may be realized as the circuit of the optical waveguide used in the respective embodiments, and/or may be realized as a circuit of an optical fiber. An optical connection portion of this optical fiber circuit may be formed by employing such a circuit that either a V-shaped groove or a U-shaped groove is formed in a substrate made of quartz, or silicon.

What is claimed is:

1. An optical device comprising:
a plurality of chips in which optical circuits are formed on substrates; wherein:
said chips are arranged in such a manner that said optical circuits are optically connected to each other;
a sandwiching member for sandwiching both upper surfaces and lower surfaces of said chips is provided in such a manner that said sandwiching member covers both an optical connection region of one optical circuit and an optical connection region of another optical circuit to be connected to each other; and
said sandwiching member contains both a flat plate member and an elastic member, while said flat plate member is provided in contact with any one of said upper surfaces and said lower surfaces of the chips, and said elastic member is provided in contact with the other side of said upper/lower surfaces.

2. An optical device according to claim 1 wherein:
said sandwiching member includes a stress applying member for applying stress to both said flat plate member and said elastic member along directions opposite to each other so as to apply the stress to the chips to be connected to each other.

3. An optical device according to claim 2 wherein:
said stress applying member applies the stress along a direction perpendicular to a plane direction of said flat plate member.

4. An optical device according to claim 2 wherein:
said stress applying member corresponds to a holding member which has an elastic U like-shape, as viewed in a sectional view thereof.

5. An optical device according to claim 1 wherein:
said flat plate member is provided in contact with the substrate, and said elastic member is provided in contact with the optical circuit forming region.

6. An optical device according to claim 1 wherein:
the chips to be connected to each other have warps; and
said chips are arranged in such a manner that warp directions thereof are directed to the same directions.

7. An optical device according to claim 6 wherein:
said flat plate member is provided on a concave-plane side of the chips to be connected to each other, and said elastic member is provided on a convex-plane side thereof.

8. An optical device according to claim 1 wherein:
both a first contact position where said flat plate member is made in contact with one chip of the chips to be connected to each other, and a second contact position where said flat plate member is made in contact with the other chip thereof are separated from a boundary position between the chips to be connected to each other by substantially equal distances.

9. An optical device according to claim 1 wherein:
said flat plate member is formed by a semiconductor material.

10. An optical device according to claim 1 wherein:
said elastic member is formed by “fluore-elastomer.”

11. An optical device according to claim 1 wherein:
said optical device is further comprised of:
an optical switch driving unit for switching connections of the optical circuits by relatively moving at least one of the chips to be connected to each other with respect to the other chip.

12. An optical device according to claim 1 wherein:
said plurality of chips are formed in such a manner that a planar lightwave circuit is separated by one, or more separating planes, while said planar lightwave circuit is formed by forming an optical circuit of an optical waveguide on a substrate;
said optical circuit includes:
at least one optical input waveguide;
a first slab waveguide connected to an output side of said at least one optical input waveguide;
an arrayed waveguide connected to an output side of said first slab waveguide;
a second slab waveguide connected to an output side of said arrayed waveguide; and
a plurality of optical output waveguides connected to an output side of said second slab waveguide, and are arranged side by side;
said arrayed waveguide includes a plurality of channel waveguides arranged side by side, the set lengths of which are different from each other, through which light conducted from said first slab waveguide is transmitted;
said separating plane corresponds to at least one of:
a plane which separates at least one of said first slab waveguide and said second slab waveguide at a plane intersected to a path of light passing through said slab waveguides;
a plane which separates a connection portion between said optical input waveguides and said first slab waveguides;
a plane which separates at least a portion of said arrayed waveguides along a longitudinal direction thereof; and
a plane which separates a connection portion between said second slab waveguide and said optical output waveguides; and wherein:
a slide moving member is provided which moves at least one of said a plurality of chips along said separating plane, depending upon a temperature.
